(19) United States
(12) Patent Application Publication
(10) Pub. No.: US 2010/0220881 A1
(43) Pub. Date: Sep. 2, 2010

(54) APPARATUS AND METHOD FOR REDUCING IMPACT SOUND EFFECTS FOR HEARING APPARATUSES WITH ACTIVE OCCLUSION REDUCTION

(75) Inventors: Georg-Erwin Arndt, Obermichelbach (DE); Volker Gebhardt, Neunkirchen Am Brand (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/701,832

(22) Filed: Feb. 8, 2010

Related U.S. Application Data
(60) Provisional application No. 61/155,959, filed on Feb. 27, 2009.

(30) Foreign Application Priority Data
Feb. 27, 2009 (DE) 10 2009 010 892.0

(51) Int. Cl. H04R 25/00

(52) U.S. Cl. 381/317

(57) ABSTRACT

The invention specifies a hearing apparatus (1) and an associated method with an active occlusion reduction unit (10). The hearing apparatus (1) also comprises at least one first means (R, M, 20, 30), which can be used to reduce an impact sound (TS) formed in the auditory canal of a wearer of the hearing apparatus (1) by steps of said wearer and/or effects on the occlusion reduction unit (10) caused by the impact sound (TS). This has the advantage that the impact sound artifacts that can be heard by a wearer of the hearing apparatus (1) are prevented.

The invention relates to a hearing apparatus specified in claim 1 with an occlusion reduction unit and a method specified in claim 10 for operating a hearing apparatus.

Occlusion refers to the closing off of the auditory canal, as occurs when a hearing apparatus, for example a hearing device, is worn. A hearing device or earpiece of the hearing device positioned in the ear seals the auditory canal off from the external environment. As a result the hearing device wearer perceives his/her own voice much more loudly and with greater distortion than usual. Occlusion is experienced as extremely unpleasant and has an adverse effect on the perception of complex ambient sound, such as speech for example.

The occlusion effects result from oscillations of the wall of the auditory canal. These oscillations are transmitted during speech or chewing from the vocal chords or other sound sources by way of so-called bone conduction. They cause the walls of the soft part of the auditory canal to oscillate, like a sound membrane. If the outer auditory canal is blocked for example by an earpiece, these oscillations generate a relatively high sound pressure level, as the sound cannot escape outward as in an open ear. The sound pressure at the ear drum here can be up to around 30 dB higher than usual. The increase in sound pressure is a function of frequency. The occlusion effect is demonstrated in particular at low frequencies below 1 kHz. The wearer's own voice can be amplified by up to 20 dB at such frequencies.

Both mechanical solutions, e.g. so-called vent openings and occlusion reduction circuits are known in order to reduce the occlusion effects occurring in a closed auditory canal. Loop filters are used here, being disposed in a feedback loop of the hearing device. The output signal of the loop filter is subtracted here from the actual audio signal, in order to achieve attenuation of the frequencies rendered too high by occlusion. In order also to compensate for the distortion caused by the occlusion reduction circuit itself, so-called equalization filters are also used, being disposed in the transmission path of the audio signal. Both the loop filter and the equalization filter are configured as static or adaptive filters.

An apparatus and method for occlusion reduction in hearing aids is described in DE 10 2006 047 965 A1.

In summary, the principle of counter sound is used with active occlusion reduction. The counter sound is determined in a loop. All the signals introduced into the loop from outside are subjected to filtering. Since to cancel occlusion sound, the corresponding counter sound must be emitted by the system with phase inversion, adequate filtering of the occlusion sound is only possible over a limited frequency range for technical reasons. It is characteristic of the loop principle used in hearing devices that signals in the frequency range of typical speech occlusion (100-1000 Hz) are reduced.

There is no reduction of the occlusion signal at both lower (up to around 100 Hz) and at higher frequencies (from around 1000 Hz), as phase inversion no longer applies here. Active occlusion reduction can result in unwanted signal distortion, in particular at a sound level induced by impact sound in the auditory canal of a walking hearing device wearer.

The object of the invention is to specify a hearing apparatus, which reduces the influence of impact sound on an active occlusion reduction.

According to the invention the specified object is achieved with the hearing apparatus of the independent claim 1 and the method for operating a hearing apparatus of the independent claim 10.

The invention claims a hearing apparatus with an active occlusion reduction unit and with at least one first means, which can be used to reduce an impact sound formed in the auditory canal of a wearer of the hearing apparatus by steps of said wearer and/or effects on the occlusion reduction unit caused by the impact sound.

This has the advantage that the impact sound artifacts that can be heard by a wearer of the hearing apparatus can be prevented.

In one development the hearing apparatus can be an in-the-ear hearing device or a behind-the-ear hearing device.

In a further embodiment the effects can comprise harmonics produced in a receiver and/or in an auditory canal microphone. It is advantageous that this interference, which is a result of non-linearities, can be prevented.

The first means can preferably comprise an auditory canal microphone and/or a receiver with a distortion factor less than 10% in the frequency range 20 to 50 Hz.

The first means can also comprise two or more receivers, one receiver having a distortion factor less than 10% in the frequency range 20 to 50 Hz.

In one development of the invention the first means can comprise an impact sound identification unit, which identifies impact sound levels in the ear canal above a predeterminable threshold value and/or impact sound frequency patterns. This allows impact sound to be identified reliably.

The impact sound identification unit can preferably comprise an acceleration and/or vibration sensor.

In a further embodiment, when impact sound is present, the amplification of the active occlusion reduction unit can be reduced adaptively or the active occlusion reduction unit can be deactivated.

The first means can also comprise a regulation element, which can be used to change the amplification of the occlusion reduction unit.

The invention also claims a method for operating a hearing apparatus with active occlusion reduction, wherein an impact sound formed by steps of a wearer of the hearing apparatus in the auditory canal of the wearer and/or effects on occlusion reduction caused by the impact sound are reduced.

Further particular features and advantages of the invention will emerge from the descriptions which follow of a number of exemplary embodiments based on schematic drawings, in which:

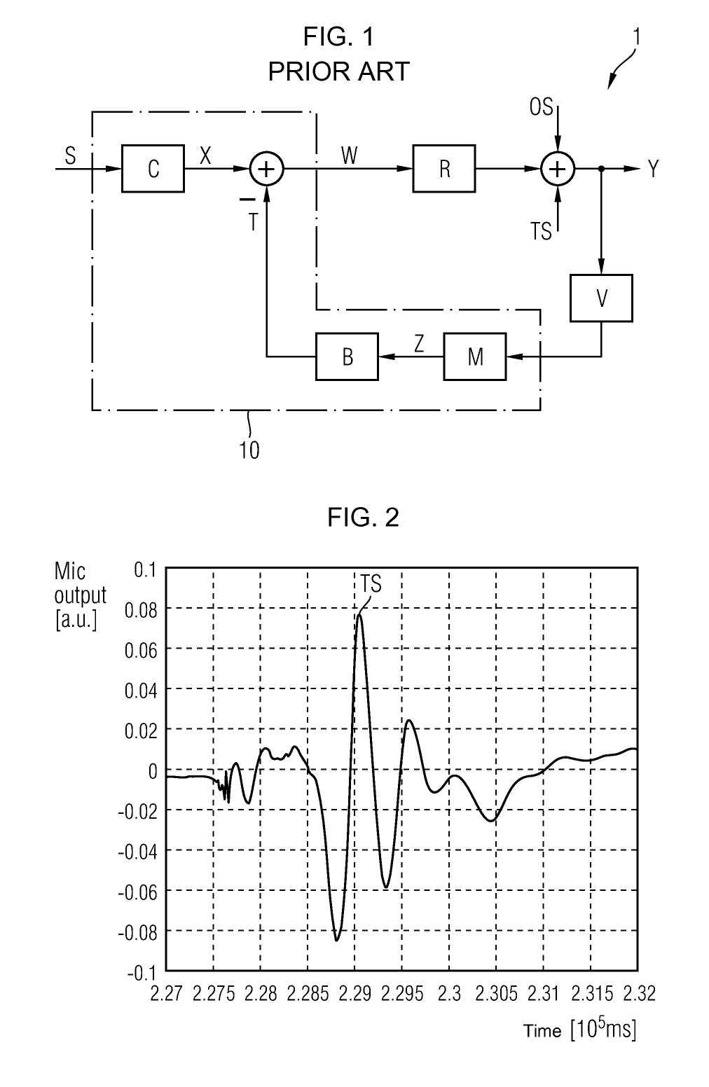

FIG. 1: shows a block circuit diagram of an occlusion reduction apparatus according to the prior art,

FIG. 2: shows a temporal profile of an individual impact sound in the ear and

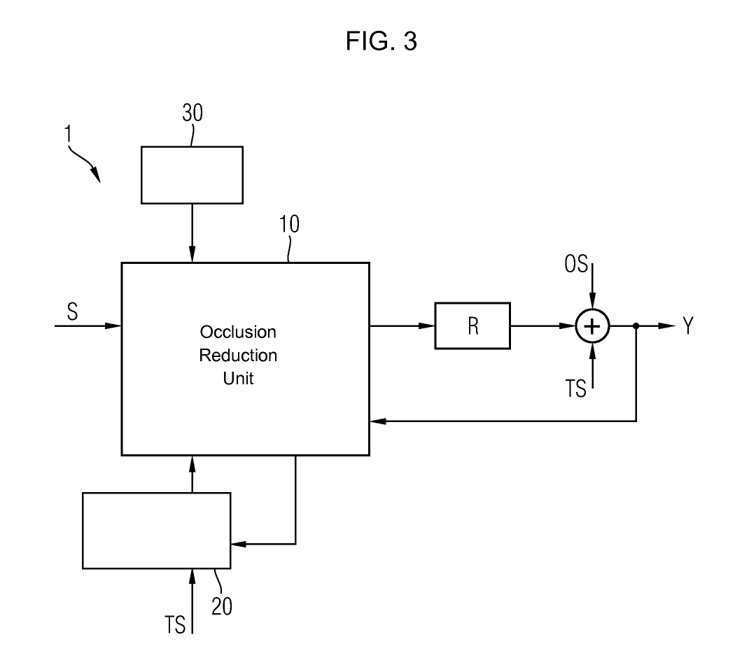

FIG. 3: shows a block circuit diagram of an active occlusion reduction with impact sound identification.

FIG. 1 shows a schematic diagram of the structure of a hearing device 1 with occlusion reduction. The hearing device 1 has a transmission path for an audio signal S. A number of signal processing components are disposed along the transmission path, with the aid of which the audio signal S is processed. The audio signal S is processed for example with the aid of filter and amplifier circuits, to compensate for an individual hearing loss. Since signal processing is generally digital in modern hearing devices, this is preferably a digital signal processing processor. At the end of the transmission path the audio signal S is emitted as a sound signal into the auditory canal by way of a receiver R, generally an electroacoustic output transducer. The output transducer R is preferably configured as a loudspeaker. To inject acoustic signals from the environment into the hearing device 1 as electrical signals, an input transducer (not shown in FIG. 1) is preferably provided, for example an input microphone. Corresponding signal inputs can also be provided for the injection of electrical signals or electromagnetic radio signals. If the hearing device 1 has digital signal processing, an analog signal injected into the acoustic device must first be digitized. An A/D (analog/digital) transducer is generally provided for this purpose at the start of the transmission path. The digital audio signal must be converted correspondingly back to an analog signal at the end of the transmission path with the aid of a D/A (digital/analog) transducer, before it can be output as an acoustic signal by way of the output transducer into the auditory canal. The D/A transducer is frequently already integrated in the output transducer, so that the electroacoustic output transducer can be actuated digitally in a direct manner.

The electronic occlusion reduction unit 10 is typically realized by means of a feedback loop, comprising an auditory canal microphone M and a filter element B. The auditory canal microphone M captures the sound field currently present in the auditory canal, which comprises an occlusion signal OS, and produces an electrical output signal Z. This signal passes through the loop filter B, in which it is formed according to the filter settings. The output signal T of the loop filter B is then subtracted from a signal X in the transmission path of the audio signal S. With optimum setting of the loop filter B the frequencies, roughly 100 to 1000 Hz, of the audio signal S in particular are attenuated, which occur with an excessive increase due to occlusion effects in the auditory canal. Any output signal Z of the auditory canal microphone M present in analog form is converted to a digital signal, before it can be further processed digitally in the feedback loop.

The occlusion reduction unit 10 connected downstream from the signal processor causes the audio signal S generally to experience linear distortion. To compensate for this distortion an equalization filter C is used. The filter C, also referred to as a predistortion filter is typically disposed in the transmission path of the audio signal S between a signal processing facility and the output transducer R.

In principle any acoustic input transducer disposed in the auditory canal can be provided instead of an auditory canal microphone M. The output transducer R and the auditory canal microphone M can also be combined utilizing the signal superposition principle. The receiver loudspeaker R for example then also acts as a sound receiver, so that there is no need for a separate auditory canal microphone M, if the circuit is designed correspondingly.

In the walking process every foot impact produces a short pulse, which is emitted to the human body. The body responds to this pulse with a pulse response and an attenuated oscillation results. The so-called impact sound TS thus produced is transmitted to the ear canal by way of bone conduction and can be measured there. FIG. 2 shows a measurement of an impact sound in the ear canal for an individual step. The impact sound TS can vary in frequency and level as a function of the person, shoes, floor quality, etc. Typically 2 to 5 wave trains per step have been measured with a frequency of 20 to 40 Hz. The impact sound level in the ear canal is also a function of how tightly the ear canal is closed off from the outside, for example by an in-the-ear hearing device or by the otoplastic of a behind-the-ear hearing device. When the ear canal is completely closed off, extremely high levels of up to 130 dB signal power can result.

The low-frequency impact sound signal TS is received by the microphone M of the occlusion reduction unit 10 in FIG. 1, filtered in the loop and emitted by the receiver R. When conventional microphones are used, as are currently employed in hearing devices, a high input level causes signal distortion. Also the receiver R is forced by the occlusion reduction unit 10 to emit such high levels, which result in conventional hearing device receivers in significant distortion of the receiver R. The transducer non-linearities thus result in the occurrence of harmonics (“distortion”), which is perceived as significant interference by a wearer of the hearing device 1.

A first means in the hearing device 1 can be used to reduce the unwanted effects (distortion, harmonics) of the impact sound according to the invention to such an extent that they are no longer perceived as interference by a hearing device wearer. The first means can have various embodiments, with a selection being described below.

In a first embodiment instead of a conventional auditory canal microphone M a special microphone is used as the first means, having a significantly lower distortion factor in the frequency range from 20 to 50 Hz at impact sound volume levels typically occurring in the ear canal than microphones M used typically in hearing devices 1. The distortion factor is typically significantly below 10%, as a distortion factor greater than 10% is experienced as interference by a hearing device wearer.

In a further inventive embodiment the receiver R is replaced by a special receiver and thus forms the first means. In contrast to receivers R typically used in hearing devices 1 the special receiver has a much lower distortion factor in the frequency range from 20 to 50 Hz at impact sound volume levels typically occurring in the ear canal.

In a further inventive embodiment the first means comprises two or more receivers. At least one receiver serves as a bass receiver, i.e. the receiver can emit low frequencies in the low distortion factor impact sound range. The further receiver(s) are designed for the remainder of the frequency range, i.e. the normal hearing device frequency range.

FIG. 3 shows a hearing device 1 with an occlusion reduction unit 10 according to FIG. 1 equipped with an impact sound identification unit 20 as the first means. The identification unit detects whether a critically high impact sound level TS occurs in the ear canal. Impact sound TS can be identified by way of a mechanical, electrical or electromechanical system. An acceleration or vibration sensor integrated in the impact sound identification unit 20 identifies the forces occurring during the walking process. In the event of a critically high impact sound level TS the occlusion reduction unit 10 adaptively reduces the amplification of active occlusion reduction, so that the non-linearities caused by receiver actuation are limited as a result. The microphone input signal is used to identify the impact sound levels and impact sound frequency patterns typically occurring in the walking process in conjunction with typical step frequencies of 0.5-2 Hz. If a “person walking” pattern is present, the hearing device adaptively reduces the amplification of active occlusion reduction at critically high impact sound levels or even deactivates active occlusion reduction.

In a further variant the impact sound frequencies of hearing device wearers are measured by a hearing device acoustician. Since impact sound levels and impact sound frequency differ significantly from person to person, this procedure allows active occlusion reduction to be set individually in an optimum manner in respect of impact sound and occlusion reduction. The impact sound frequency can be measured for example with universal ear plugs with integrated microphones. Both impact sound frequency and levels are recorded. This preliminary measurement also makes it possible to decide whether a device with an acceptable occlusion reduction effect can be built for the person in question.

In a further configuration of the invention the loop setting of the occlusion reduction unit 10 can be set individually by individual feedback from the hearing device wearer. This requires the availability of algorithmic adjustment options, which can be used to change the extent of the impact sound effect. The bandwidth of the setting options can be made available to the hearing device wearer by means of the adjustment software continuously by way of a regulation element 30 or by way of a selection of fixed settings. The value of the regulation element 30 is specified individually by feedback from the hearing device wearer in relation to impact sound artifacts at an adjustment session.

### LIST OF REFERENCE CHARACTERS

1 Hearing device

10 Occlusion reduction unit

20 Impact sound identification unit

30 Regulation element

B Filter element

C Equalization filter

M Auditory canal microphone

OS Occlusion signal

S Audio signal

T Output signal of filter element B

TS Impact sound

R Receiver

X Signal after equalization filter

Z Output signal of auditory canal microphone M

1. A hearing apparatus, comprising:
an active occlusion reduction unit; and
at least one first means configured to reduce an impact sound formed in an auditory canal of a wearer of the hearing apparatus by steps of said wearer and/or effects on said occlusion reduction unit caused by the impact sound.

2. The hearing apparatus according to claim 1, formed as an in-the-ear hearing device or a behind-the-ear hearing device.

3. The hearing apparatus according to claim 1, wherein the effects on said occlusion reduction unit comprise harmonics produced in a receiver and/or in an auditory canal microphone.

4. The hearing apparatus according to claim 1, wherein said first means comprises at least one of an auditory canal microphone and a receiver with a distortion factor less than 10% with impact sound volume levels occurring in a frequency range from 20 to 50 Hz.

5. The hearing apparatus according to claim 1, wherein said first means comprises a plurality of receivers, one of said receivers having a distortion factor less than 10% with impact sound volume levels occurring in a frequency range from 20 to 50 Hz.

6. The hearing apparatus according to claim 1, wherein said first means comprises an impact sound identification unit configured to identify impact sound levels in the auditory canal above a predeterminable threshold value and/or impact sound frequency patterns.

7. The hearing apparatus according to claim 6, wherein said impact sound identification unit comprises at last one of an acceleration sensor and a vibration sensor.

8. The hearing apparatus according to claim 6, wherein when impact sound is present, an amplification of said active occlusion reduction unit can be reduced adaptively or said active occlusion reduction unit can be deactivated.

9. The hearing apparatus according to claim 1, wherein said first means comprises a control element enabling an amplification of said occlusion reduction unit to be changed.

10. The hearing apparatus according to claim 1, wherein said control element is a regulation element to be used by a wearer of the hearing apparatus or by an acoustician to change the amplification of said occlusion reduction unit.

11. A method for operating a hearing apparatus with active occlusion reduction, which comprises:
determining a presence of an impact sound generated by steps of a wearer of the hearing apparatus; and
actively reducing the impact sound caused by steps of the wearer of the hearing apparatus in the auditory canal of the wearer and/or effects on occlusion reduction caused by the impact sound.
